(19) United States
(12) Patent Application Publication
(10) Pub. No.: US 2012/0261599 A1
(43) Pub. Date: Oct. 18, 2012

(54) SYSTEM AND METHODS OF SOLENOID VALVE AUTOMATION TO OPEN AND CLOSE POSITION

(76) Inventor: Ferdinand Villegas Legaspi, Chino, CA (US)

(21) Appl. No.: 13/271,151

(22) Filed: Oct. 11, 2011

Related U.S. Application Data
(60) Provisional application No. 61/344,837, filed on Oct. 21, 2010.

(51) Int. Cl. F16K 31/06

(52) U.S. Cl. 251/129.04

(57) ABSTRACT

This device is a portable remote control knob that can replace the cooking appliances manual control knobs which is automatically set back to off position via wired or wireless methodology. The system is applicable to most cooking appliances that can be set to turn off the knobs remotely, wherein the appliance gas valve or electric control switch is remotely rotated to shutoff position. The device composed of solenoid coils, springs, sprocket, audio interface, wireless modules, motor assembly and remote control module for engaging appliances operational shaft and which, when rotated to activate the appliances it actuates the remote transceiver module. The remote transmitter device have LED indicator when the remote knob is activated. This transmitter device may include programming to adjust timer modes of the appliances knobs.

### CLAIM OF PRIORITY

The present Application for Patent claims priority to U.S. Provisional Application No. 61/344,837 entitled “Methods of converting solenoid valve to open and close position”, Oct. 21, 2011 with confirmation no. 3060, and hereby expressly incorporated by reference herein.

### FIELD

The present invention relates to the field of automated capabilities of solenoid valve to open and close positions. The system employs the energy savings methodology to hold the solenoid valve in desired services such as open or closed position.

### BACKGROUND OF THE INVENTION

Solenoid valve is the most useful units in many gas and liquid controlled appliances. Majority of the valves have a continuous consumption of energy to keep the valves in open or closed position, there are instances that solenoid valves overheats by fluctuating currents. The present invention refers to a solenoid valves with two isolated magnetic coils that make the valve into a neither open nor closed position. It does not consume energy continuously but it holds the valve plunger to open or closed utilizing springs and lock pin controlled by solenoid coils.

Solenoid valve overheating is dangerous to consumers and sometimes caused by fire triggered by natural gas or methane gas. In most household appliances like gas stove, heater and dryer utilizes solenoid valve however, if the valves overheats the plunger is sometimes welded to the overheated coil that locks the valve to open position which place the consumers into a dangerous situation against gas leaks. The present invention does not overheat and energy efficient solenoid valve. It can be designed to a closed position using a controlling capacitor to keep the plunger closed whenever power line is down or cut off.

To avoid solenoid valve from overheating caused by continuous consumption of energy, the source of energy must interrupted or shut-off from the source. The present invention contains solenoid coils in one valve that performs separate tasks by application of peak power distribution. It is energy efficient and does not overheat.

Consequently, an energy saving system and methods of solenoid valve automation to open and close position is needed in most household appliances and commercial machineries.

### SUMMARY

One feature of the present invention provides an energy efficient valve with an interrupted power source to prevent overheating of solenoid elements. The innovated solenoid valve has at least one plunger, one lock pin, two solenoids and springs compounded together in the valve housing. The valve is capable to maintain open or closed. The springs push the pin lock and the plunger. The coil magnetic induction pulls the pin and the plunger to open and closed the valve.

The valve have automatic switch module to cut-off the power supply to the solenoid when power peak is distributed. It has a self charging capacitor to hold energy and release the hold energy when the power source is down.

Another feature of the present invention provides the programming remotely to an open or close position using Radio Frequency, Bluetooth or WiFi signal connected to controlling interface.

Other safety feature of the present invention provides a safety ball bearing attached to the spring inside the plastic chamber. In case of fire, the extreme heat will melt the plastic chamber to release the bearing and permanently block the valve orifice.

The most extended feature is the valve adjustable knobs that can adjust the pushing power of the plunger to hold different PSI. This knob has a spring that is connected to the thread and the plunger.

### BRIEF DESCRIPTION OF THE DRAWINGS

FIG. 1 is a block diagram illustrating the wireless operational overview of system and methods of valve automation to open or closed position.

FIG. 2 is a block diagram illustrating the manual operation overview of system and methods of valve automation to open or closed position.

FIG. 3 is the illustrations of the methodological process of the ball bearing, springs and plastic chamber safety principles and operations

FIG. 4 is the illustrations of the solenoid valve system operations

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention. In the following description, specific details are given to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, structures and techniques may not be shown detail in order not to obscure the embodiments.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, a storage medium may represent one or more devices for storing data, including read-only memory (ROM), random access memory (RAM), magnetic disk storage mediums, optical storage mediums, flash memory devices and/or other machine readable mediums for storing information. The term “machine readable medium” includes, but is not limited to portable or fixed storage devices, optical storage devices, wireless channels and various other mediums capable of storing, containing or carrying instruction(s) and/or data. Furthermore, embodiments may be implemented by hardware, software, firmware, middleware, microcode, or any combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The various illustrative logical blocks, modules, circuits, elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing components, e.g., a combination of a DSP and a microprocessor, a number of microprocessors, one or more microprocessors in conjunction with a DSP core, or any other such configuration.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

In the following description, certain terminology is used to describe certain features of one or more embodiments of the invention. The term “valve” refers to a gas valve type of device that regulates, directs or controls the flow of gaseous compound, opening, closing, or partially obstructing various passageways. Valves are technically pipe fittings but are usually discussed as a separate category.

Embodiments of the invention are directed to systems and methods of solenoid valve automation to open and close position. The system may include energy efficient solenoid valve which does not use electrical source unless it is trigger to close or to open position.

In other words, the valve does not continuously use energy and utilize it mechanical methodology in keeping it open or in close position. It uses lock pin, plunger and springs to hold the desired position.

According to another aspect, the interruption of the flow of the gases to the valve from the peak power distribution of the power control modules and the relay switches. The switches may be in a no contact (N.C.) position until triggered by manual or wireless signal.

Further aspect is that the valve works free from overheating and maintains its normal temperature that leads to perform its function more efficient and long lasting.

According to yet another embodiment, the valve has a single ball or bearing compounded with a spring and hold tightly in a plastic chamber. The fire extreme heat is enough to melt the plastic to release the bearing ball and it is forced or pushed by the spring to block the valve orifice and stop the flow of the gas permanently. This safety device was included to this innovation to prevent gas leaks when fire occurs.

### Overview

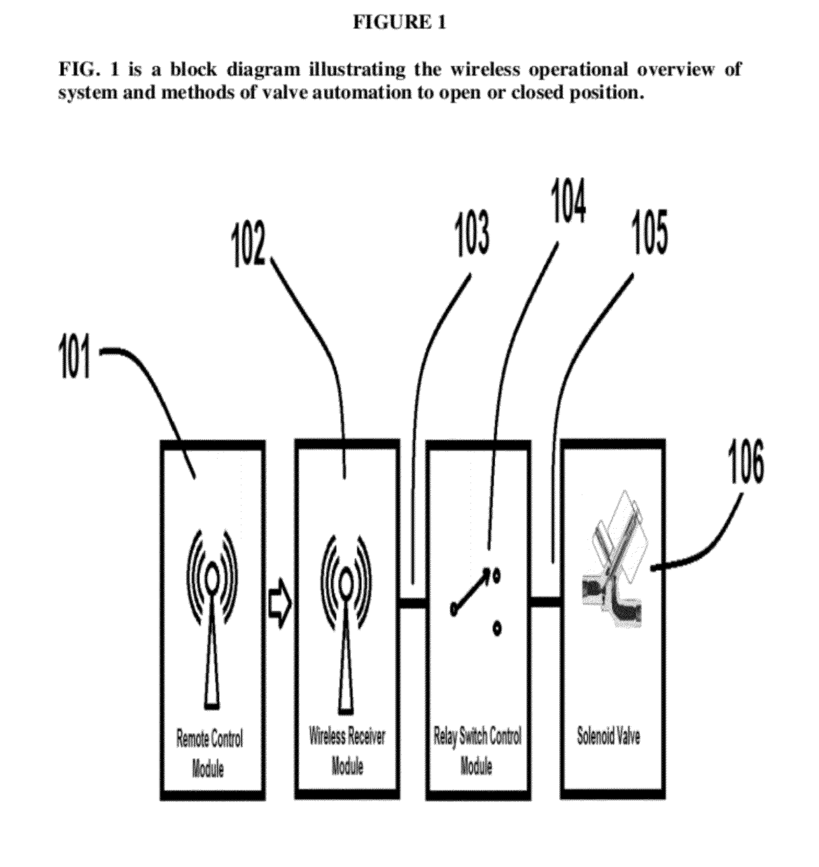

FIG. 1 is a block diagram illustrating the wireless operational overview of system and methods of valve automation to open or closed position. As shown in 101 which is the remote control module has the same wireless frequency signal with the 102 which is the wireless receiver module. It can remotely open or close the orifice of the 106 solenoid valve utilizing 104 which is the relay switch control module. This module is directly connected to the wireless receiver module as shown in line 103. Block 104 is directly interconnected by line 105 to the block 106. The remote controller 101 can set the solenoid valve to open position when 104 relay switch control module is fixed to open position which means the lock pin mechanism of the valve is design to hold the plunger into an open position. When the remote controller set the valve to a closed position, even when power supply is down, the charged capacitor of the relay switch control module will automatically activates to discharge its energy to lock and closed the orifice.

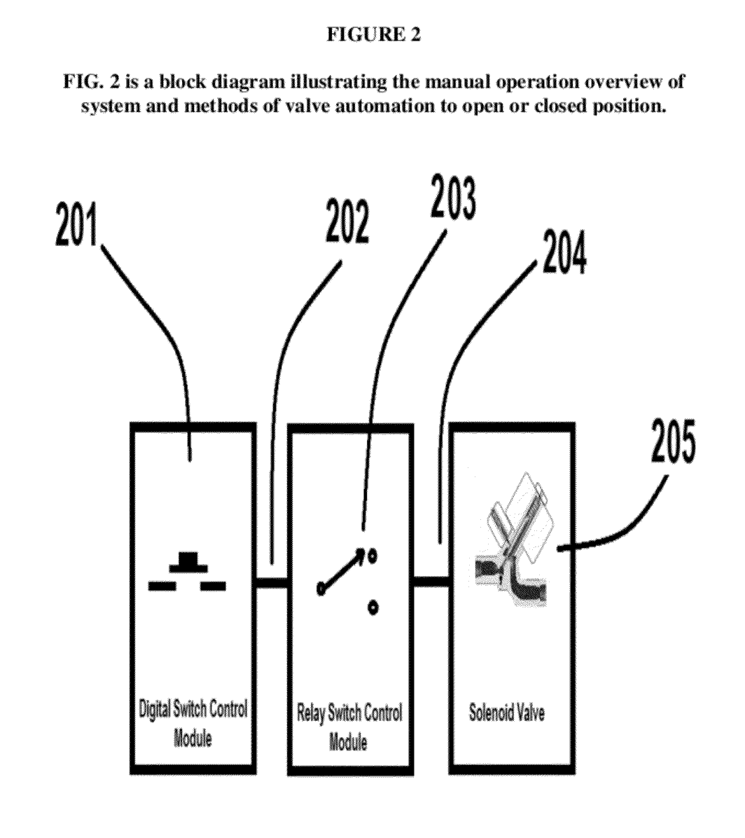

FIG. 2 is a block diagram illustrating the manual operation overview of system and methods of valve automation to open or closed position. The three blocks are interconnected by lines 202 and 204. The Digital Switch Control Module 201 is the main controller to program the solenoid valve 205 into an open and closed position. It controls the Relay Switch Control Module 203 to keep the valve open or closed. The Digital Switch Control Module 201 can set the solenoid valve 205 to open position when relay switch control module 203 is programmed to open position. When the remote controller set the valve to a closed position, even when power supply is down, the charged capacitor of the relay switch control module will automatically activates to discharge peak energy to lock and closed the orifice.

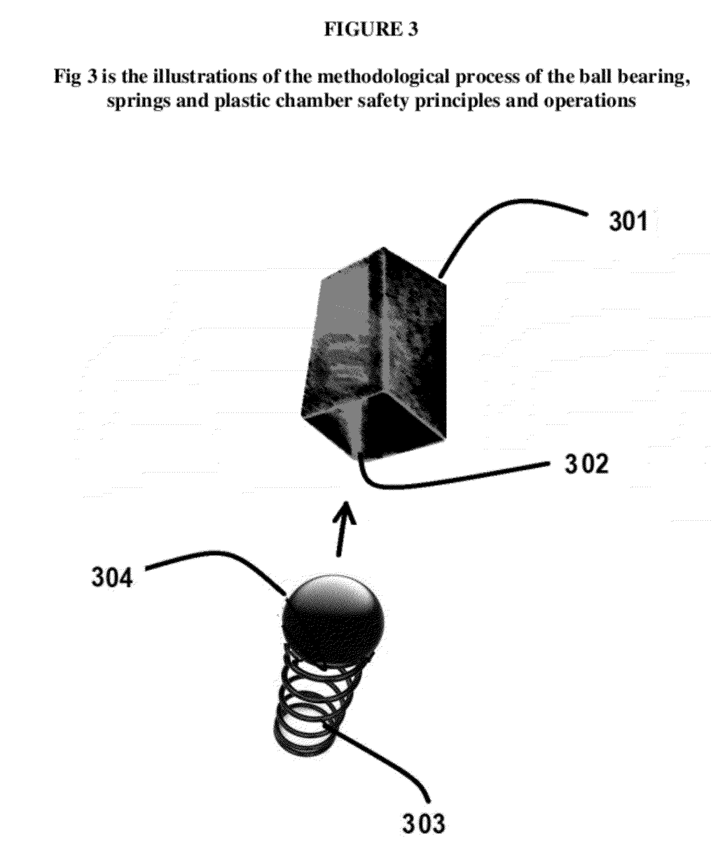

FIG. 3 is the illustrations of the methodological process of the ball bearing, springs and plastic chamber safety principles and operations. As shown in plastic container 301 contains chamber 302 at the bottom with enough circumference to hold the ball bearing 304 and the spring 303. Both spring and ball bearing are placed inside the casing and will be inserted to the valve as an emergency orifice blocker. The principle behind this is that the plastic casing used to hold the ball bearing and in case of fire extreme heat at the valve, the plastic will melt to release the ball bearing to block the valve orifice permanently.

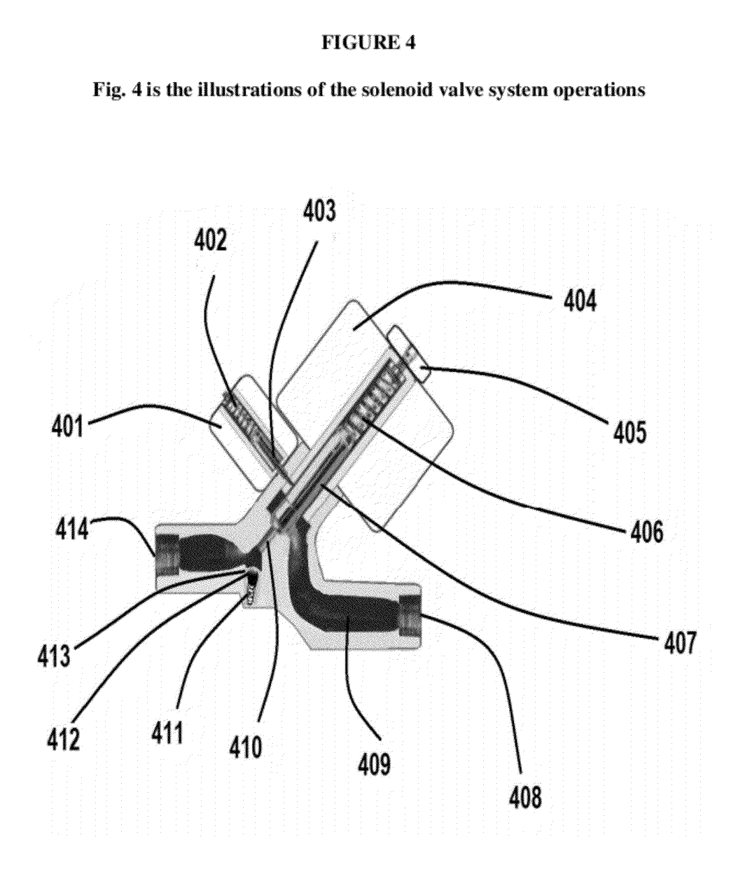

FIG. 4 is the illustration of the valve system operation wherein the first solenoid coils 401 has a locking pin mechanism 403 with a spring 402 to hold the plunger 407 into an open position. To keep the valve open, the energy is applied to second solenoid coil 404 to pull the plunger 407 up and hold open by pin locking mechanism 403. The second solenoid 404 contains adjustable knob 405 to control the force of the spring 406 into a different PSI. To keep the valve closed, the first solenoid coil 401 is energized by charged capacitor through system relay control module wherein, if the power source is cut off, the relay will collapse to connect its pole to the charged capacitor and release peak energy. The energized coils will pull-up the locking pin 403 mechanism that turns the plunger 407 to freely close the orifice 410. The gas valve input 414 goes directly to the orifice 410 and tube 409 is the output directly to 408. In case of extreme heat or fire within the valve, the plastic chamber 413 will melt to release the ball bearing 412. The spring 411 will push the bearing to permanently block the orifice.

1-19. (canceled)

20. A remote control knob, comprising:
a control module for receiving and distributing power from a power source;
a motor in communication with the control module for rotating the remote control knob;
a solenoid coil, in communication with the control module for switching a flow of power to an appliance connected to the remote control knob; and
a receiver module, in communication with the control module, for receiving audible sounds.
